(19) United States
(12) Patent Application Publication
(10) Pub. No.: US 2011/0288941 A1
(43) Pub. Date: Nov. 24, 2011

(54) CONTEXTUAL CONTENT ITEMS FOR MOBILE APPLICATIONS

(75) Inventors: Deepak Chandra, Mountain View, CA (US); Zhenyu Liu, San Jose, CA (US)

(73) Assignee: GOOGLE INC., Mountain View, CA (US)

(21) Appl. No.: 12/784,491

(22) Filed: May 20, 2010

(51) Int. Cl. G06F 15/16; G06Q 30/00

(52) U.S. Cl. 705/14.73; 709/217; 705/26.61

(57) ABSTRACT

This specification describes technologies relating to content presentation. In general, one aspect of the subject matter described in this specification can be embodied in methods that include the actions of receiving a request to serve a content item to an application on a mobile device; identifying a context associated with the application, the context being derived from an application description page for the application and one or more pages linking to the application description page, the context comprising one or more keywords associated with the application; selecting a content item, from a collection of content items, using the context; and serving the selected content item to the application on the mobile device. Other embodiments of this aspect include corresponding systems, apparatus, and computer program products.

### BACKGROUND

The present disclosure relates to content presentation.

Advertisers provide advertisements in different forms in order to attract consumers. An advertisement (“ad”) is a piece of information designed to be used in whole or part by a user, for example, a particular consumer. Ads can be provided in electronic form. For example, online ads can be provided as banner ads on a web page, as ads presented with search results, or as ads presented in a mobile application.

One can refer to the inclusion of an ad in a medium, e.g., a webpage or a mobile application, as an impression. An advertising system can serve an ad to an application on a mobile device, for example, in response to the user running the application. If a user selects the presented ad (e.g., by “clicking” the ad), then the user is generally taken to another location associated with the ad, for example, to another, particular web page.

### SUMMARY

This specification describes technologies relating to content presentation.

In general, one aspect of the subject matter described in this specification can be embodied in methods that include the actions of receiving a request to serve a content item to an application on a mobile device; identifying a context associated with the application, the context being derived from an application description page for the application and one or more pages linking to the application description page, the context comprising one or more keywords associated with the application; selecting a content item, from a collection of content items, using the context; and serving the selected content item to the application on the mobile device. Other embodiments of this aspect include corresponding systems, apparatus, and computer program products.

These and other embodiments can optionally include one or more of the following features. The content item is an advertisement. The context includes one or more of: news, sports, finance, music, television, travel, games, or food. The application description page includes one of a page where the application can be purchased; or a review of the application written by a user of the application. The context is based on a page context for each of the pages linking to the application description page. The application description page and the pages linking to the application description page are included in an index of pages. Serving the selected content item includes: determining one or more candidate content items; determining whether the context for the application matches the one or more candidate content items; modifying a score of each candidate content item determined to match the context for the application; and selecting the selected content item from the one or more candidate content items using the scores for the candidate content items. Each candidate content item is associated with one or more ad contexts, and where the ad contexts are identified using advertiser supplied keywords.

In general, one aspect of the subject matter described in this specification can be embodied in methods that include the actions of identifying an application description page for an application for mobile devices; identifying one or more pages linking to the application description page; and determining a context for the application based on the application description page and the one or more pages linking to the application description page, the context comprising one or more keywords associated with the application. Other embodiments of this aspect include corresponding systems, apparatus, and computer program products.

These and other embodiments can optionally include one or more of the following features. The application description page comprises one of: a page where the application can be purchased; or a review of the application written by a user of the application.

Particular embodiments of the invention can be implemented to realize one or more of the following advantages. Applications for mobile devices can be associated with contextual information based on pages linking to a page describing the mobile device application. This is useful because, unlike typical web pages, mobile applications do not generally include text that can be used to determine contextual information. Content items (e.g., ads) can be targeted to particular applications on mobile devices using the context. For various mobile applications, a page describing the mobile application already exists in an application store and hence context can be determined without further input from the application developer.

Also, because a determined context for a mobile application is based on indirect signals (e.g., application reviews, other pages on the web, and application description pages where the application can be bought) rather than direct input from an application publisher or developer, that context is less susceptible to targeting spam. Targeting spam is a form of spam where an application publisher provides deceptive context (e.g., misleading or completely false information) about the application in the hope of getting higher paying ads. Furthermore, since the indirect signals are visible to users, the application publisher has less incentive to supply deceptive information with the hope of getting more lucrative ads targeted to the application.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 is a block diagram of an example content presentation system.

FIG. 2 is a block diagram of an example ad system for serving content items to applications on mobile devices.

FIG. 3 is a diagram illustrating two example application description pages for an application and example linking pages.

FIG. 4 is a flow chart of an example process for associating an application with one or more contexts.

FIG. 5 is a flow diagram of a process for serving one or more ads.

Like reference numbers and designations in the various drawings indicate like elements.

### DETAILED DESCRIPTION

Advertisers seek to have content items (e.g., ads) presented to users likely to be interested in the content items. For example, content items can be targeted to users based on an application that the user is using on a mobile device. In particular, mobile device applications can be associated with one or more contexts indicative of the subject matter of the application, or topics of interest to users of the application. In some implementations, descriptions in content associated with an application are used to provide context for targeting content items to the mobile applications. Content items matched to these contexts can be boosted by a system when determining content items to serve to users.

While reference will be made below to advertising systems and processes, other forms of content including other forms of sponsored content can be managed and presented in accordance with the description below.

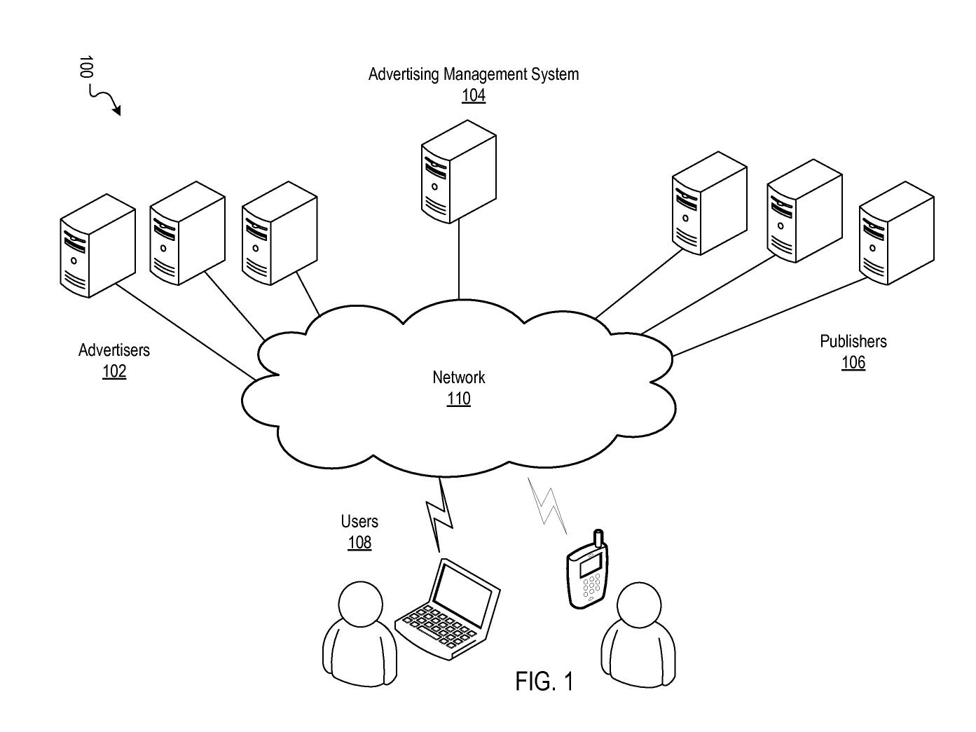

FIG. 1 is a block diagram of an example content presentation system 100. In some implementations, one or more advertisers 102 can directly, or indirectly, enter, maintain, and track ad information in an advertising management system 104. Though reference is made to advertising, other forms of content, including other forms of sponsored content, can be delivered by the system 104. The ads can be in the form of graphical ads, such as banner ads, text only ads, image ads, barcode ads (e.g., ads including one or more barcodes, for example, to use in redeeming the ad), audio ads, video ads, ads combining one or more of any of such components, and so on. The ads can also include embedded information, such as links, meta-information, and/or machine executable instructions.

One or more publishers 106 can submit requests for ads to the system 104. The advertising management system 104 responds by sending ads to the requesting publisher 106 for placement on, or association with, one or more of the publisher's content items (e.g., web properties). Example web properties can include web pages, television and radio advertising slots, or print media space. Web properties can appear in applications for mobile devices.

Other entities, such as users 108 and 110 and advertisers 102, can provide usage information to the system 104, for example, whether or not a conversion (e.g., a purchase or other interaction) or a click-through related to an ad (e.g., a user has selected an ad) has occurred. This usage information can include measured or observed user behavior related to ads that have been served. In some implementations, the advertising management system 104 performs financial transactions, for example, crediting the publishers 106 and charging the advertisers 102 based on the usage information.

A network 112, such as a local area network (LAN), wide area network (WAN), the Internet, one or more telephony networks or a combination thereof, connects the advertisers 102, the system 104, the publishers 106, and the users 108 and 110.

One example publisher 106 is a general content server that receives requests for content (e.g., articles, discussion threads, music, video, graphics, search results, web page listings, information feeds, and so on), and retrieves the requested content in response to the request. The content server can submit a request for ads to an advertisement server in the advertising management system 104. The ad request can include a number of ads desired. The ad request can also include content request information. The content request information can include the content itself (e.g., page, video broadcast, radio show, or other type of content), a category corresponding to the content or the content request (e.g., arts, business, computers, arts-movies, arts-music, and so on), part or all of the content request, content age, content type (e.g., text, graphics, video, audio, mixed media, and so on), geo-location information, and so on.

In some implementations, the content server (or a client browser or the like) can combine the requested content with one or more of the ads provided by the advertising management system 104. The combined content and ads can be served (e.g., sent/rendered) to the users 108 that requested the content for presentation in a viewer (e.g., an application on a mobile device). The content server can transmit information about the ads back to the advertisement server, including information describing how, when and/or where the ads are to be rendered (e.g., in hypertext markup language (HTML) or JavaScript™).

Another example publisher 106 is a search service. A search service can receive queries for search results. In response, the search service can retrieve relevant search results from an index of documents (e.g., from an index of web pages). Search results can include, for example, lists of web page titles, snippets of text extracted from those web pages, and hypertext links to those web pages, and can be grouped into a predetermined number (e.g., ten) of search results.

The search service can submit a request for ads to the advertising management system 104. The request can include a number of ads desired. This number can depend on the search results, the amount of screen or page space occupied by the search results, the size and shape of the ads, and so on. In some implementations, the number of desired ads will be from one to ten, or from three to five. The request for ads can also include the query (as entered or parsed), information based on the query (such as geo-location information, whether the query came from an affiliate and an identifier of such an affiliate), and/or information associated with, or based on, the search results. The information can include, for example, identifiers related to the search results (e.g., document identifiers of “docIDs”), scores related to the search results (e.g., information retrieval (“IR”) scores), snippets of text extracted from identified documents (e.g., web pages), full text of identified documents, feature vectors of identified documents, and so on. In some implementations, IR scores can be computed from, for example, dot products of feature vectors corresponding to a query and a document, page rank scores, and/or combinations of IR scores and page rank scores, and so on.

In some implementations, the advertising management system 104 includes an auction process to select ads from the advertisers 102. For example, the advertisers 102 can be permitted to select, or bid, an amount the advertisers are willing to pay for each presentation of or interaction with (e.g., click) of an ad, e.g., a cost-per-click amount an advertiser pays when, for example, a user clicks on an ad. The cost-per-click can include a maximum cost-per-click, e.g., the maximum amount the advertiser is willing to pay for each click of an ad based on a keyword, e.g., a word or words in a query. Other bid types, however, can also be used. Based on these bids, ads can be selected and ranked for presentation.

The search service can combine the search results with one or more of the ads provided by the system 104. This combined information can then be forwarded to the users 108 and 110 that requested the content. The search results can be maintained as distinct from the ads, so as not to confuse the user between paid ads and presumably neutral search results.

In some implementations, one or more publishers 106 can submit requests for ads to the advertising management system 104. The system 104 responds by sending ads to the requesting publisher 106 for placement on one or more of the publisher's web properties (e.g., websites and other network-distributed content) that are relevant to the web property. For example, if a publisher 106 publishes a sports-related web site, the advertising management system can provide sports-related ads to the publisher 106. In some implementations, the requests can instead be executed by devices associated with the users 108 and 110, e.g., by the execution of a javascript when the publisher's web page is loading on a client device.

Another example publisher 106 is a mobile application developer. A mobile application is an application specifically designed for operation on a mobile device (e.g., a smartphone). The mobile application can also include ads positioned within the content of the mobile application. The ads can be received from the system 104 for placement in the mobile application when accessed by a user (e.g., when a particular page of a mobile application is loaded on the mobile device).

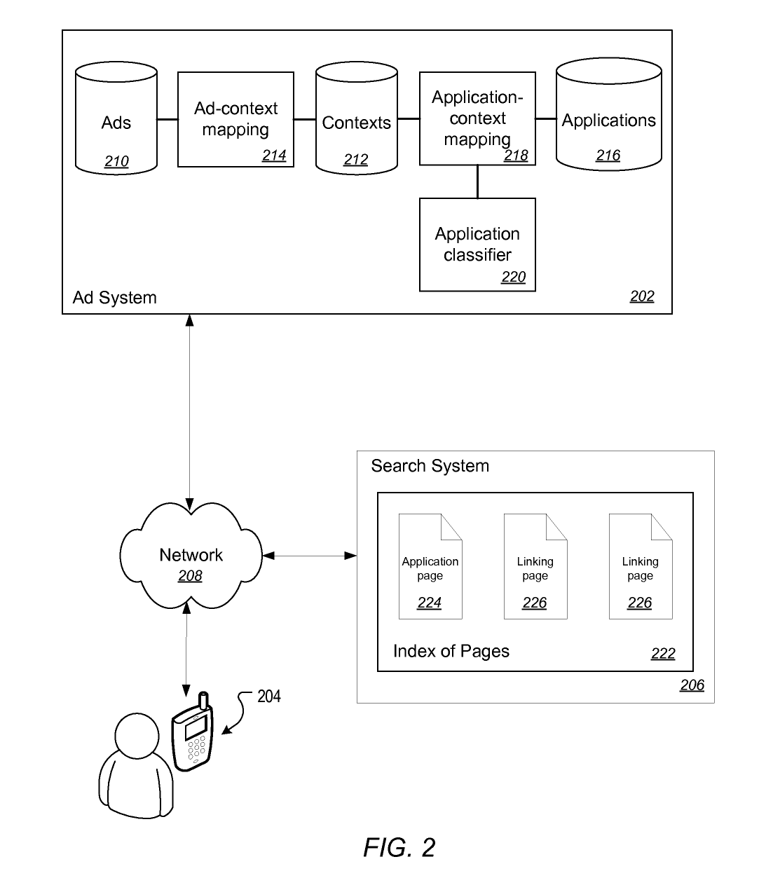

FIG. 2 is a block diagram of an example ad system 202 for serving content items to applications on mobile devices (e.g., mobile device 204).

The ad system 202 can interact with a mobile device 204 and a search system 206 through a network 208 (e.g., a local area network (LAN), wide area network (WAN), the Internet, one or more telephony networks, cellular networks, or combinations thereof). The mobile device 204 can receive one or more ads, directly or indirectly, from the ad system 202.

Various applications run on the mobile device 204 and display ads. An application includes computer software operable to perform certain tasks. For example, some applications display news, sports scores, financial info, or the like, and some applications provide music, games, and so on. The ad system 202 can selects different ads to serve to the mobile device 204 based on which application on the mobile device is requesting ads.

The ad system 202 includes an ads repository 210 and a contexts 212. A context comprises information indicative of the subject matter of something (e.g., an application, an ad, a web page, and so on.) Typically, a context includes a keyword (or string of keywords) that summarizes or relates to topics or categories of information. Example contexts include news, sports, finance, music, television, travel, games, food, and so on.

One or more of the ads in the ads repository 210 can be associated with one or more contexts 212. The ad-context mapping 214 associates ads from the ads repository 210 with contexts 212. For example, an ad for a radio station can be associated with a “music” context (or a “radio” context or both), an ad for financial services can be associated with a “finance” context, and so on. In some implementations, ads are associated with contexts using advertiser (e.g., advertisers 102) supplied keywords.

The ad system 202 also includes a catalog of application identifiers 216. Typically, the ad system 202 does not include the actual applications (e.g., executable code). In some implementations, an application is identified by a textual name and optionally a publisher, a mobile operating system, or the like. In some implementations, each application is associated with an application description page or a link to an application description page.

One or more applications in the catalog of applications 216 can be associated with one or more contexts 212. The application-context mapping 218 associates applications from the catalog of applications 216 with contexts 212. For example, an application that plays music can be associated with a “music” context, an application for online banking can be associated with a “finance” context (or a “banking” context or both), and so on.

The application classifier 220 determines which applications are associated with which contexts. Applications can be classified using various techniques. In some implementations, certain techniques are used to classify some applications, and other techniques are used to classify other applications.

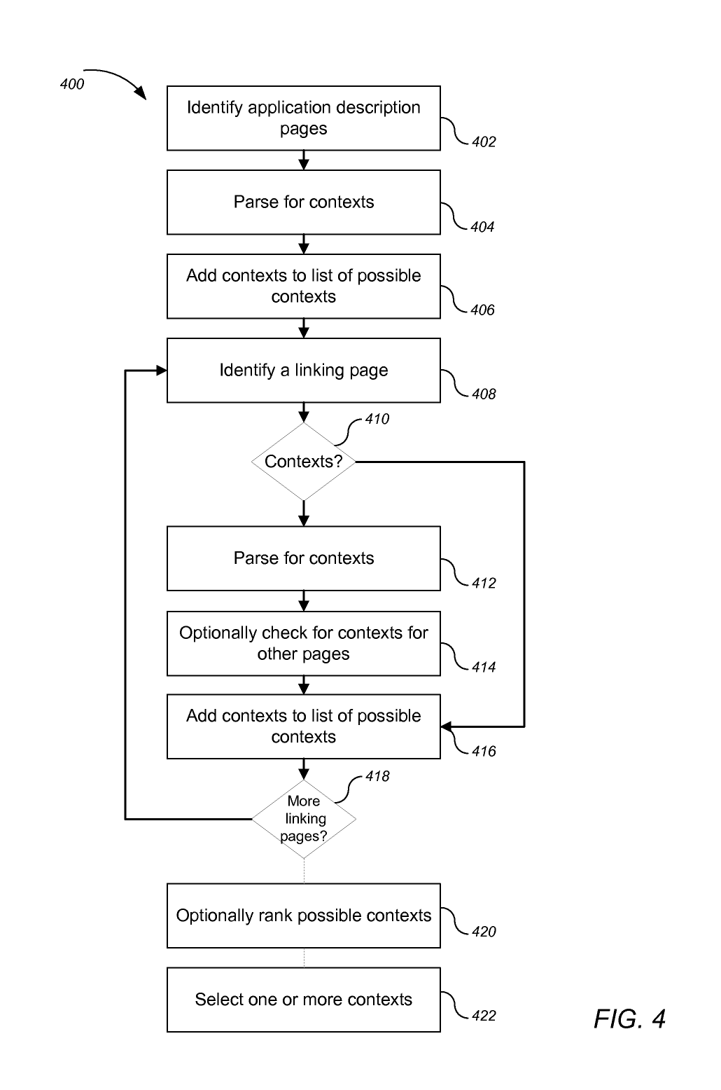

For example, in some implementations, self-identifying applications send contexts that they are associated with when requesting ads, and other applications do not send contexts. In those implementations, the self-identifying applications can be classified according to their self-identified contexts. However, in some other implementations, the application provided contexts are not dispositive in classifying the application. Applications can also be classified using other techniques (for example, technique 400, described in detail below with respect to FIG. 4.)

Classifying an application is typically more difficult than, for example classifying a web page. Contexts for a web page can be identified by parsing the web page for textual cues (e.g., keywords, phrases, writing styles, and so on). An application typically cannot be directly parsed for textual cues (for example, where there is no access to the text content of the application or the application's source code).

The application classifier 220 uses an index 222 of web pages. In some implementations, the index 222 is part of the search system 206. For example, the search system 206 can crawl the Internet and store crawled pages in the index 222. The index 222 can be used for both providing search results and for classifying applications. In other implementations, the index 222 is part of the ad system 202 or another system (not shown).

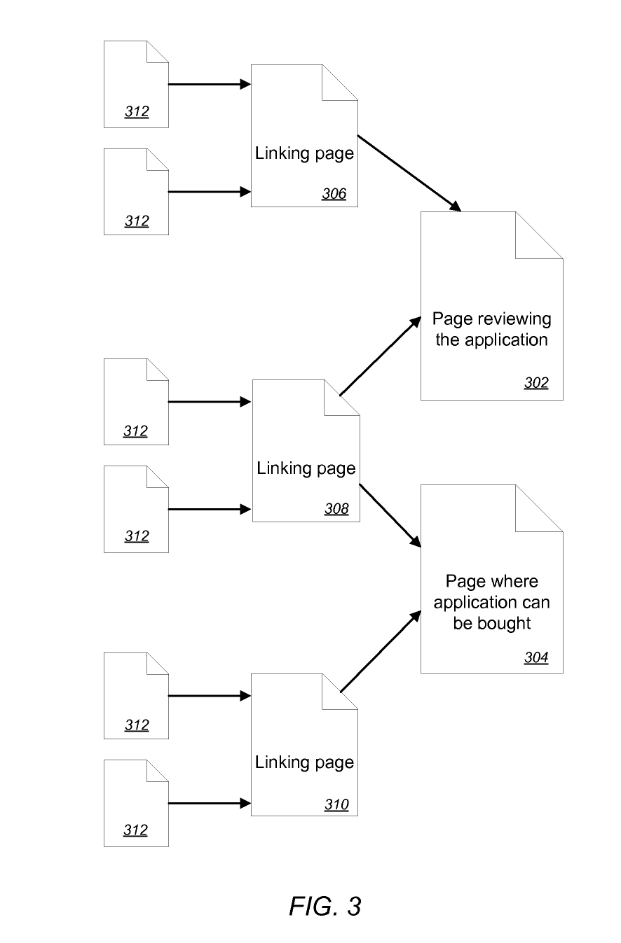

The index 222 includes one or more application description pages 224. Application description pages are described in greater detail below with respect to FIG. 3. The index 222 also includes one or more linking pages 226 (pages that link to the application description pages 224). The application classifier 220 uses the application description pages 224 and the linking pages 226 to classify applications.

FIG. 3 is a diagram illustrating two example application description pages 302 and 304 for an application and example linking pages 306, 308, and 310.

An application description page is a web page that is related to an application. For example, an application description page can be a review of an application on a user's blog, a review of an application by an online magazine, a descriptive page created by the application's publisher or developer, a page where the application can be purchased, and so on.

A linking page is a page that links to an application description page (e.g., contains a hyperlink to the application description page). For example, a linking page can be commentary on the application description page, an advertisement for the application description page, documentation for the application referring to the application description page, and the like.

In FIG. 3, the first example application description page 304 is a review of the application (e.g., written on a blog). The second example application description page 306 is a page where the application can be bought (e.g., at an online application store).

Three linking pages 306, 308, and 310 are illustrated. The first linking page 306 links to the first application description page 304. The second linking page 308 links to both the first application description page 302 and the second application description page 304. The third linking page 310 links to the second application description page 310. Other pages 312 link to the respective linking pages.

An application classifier (e.g., application classifier 220 or the like) can use the application description pages 302 and 304 and the linking pages 306, 308, and 310 to determine one or more contexts associated with the application. In some implementations, each page is parsed for textual cues, and contexts are associated with the pages based on the textual cues. In some implementations, other pages 312 linking to the linking pages 306, 308, and 310 are used to determine contexts associated with the linking pages 306, 308, and 310. The contexts of the linking pages 306, 308, and 310 and the application description pages 302 and 304 can be associated with the application.

In some implementations, contexts associated with the pages are ranked based on how likely they are to be related to the application. For example, contexts associated with the second linking page 308 can be ranked higher than contexts associated with the first and third linking pages 306 and 310 because the second linking page 308 links to both application description pages 302 and 304. Contexts can also be ranked based on other factors, for example, how many linking pages they are associated with, where their textual cues appear in the linking pages (e.g., how close to the hyperlink to an application description page), how many times the name of the application is mentioned in the associated linking page, and so on.

In some implementations, contexts associated with the pages are only associated with the application if those contexts meet certain criteria. For example, a context can be associated only if it is associated with a threshold number of pages. In some other implementations, only a certain number (e.g., the top five or ten) of contexts associated with the pages are associated with the application.

FIG. 4 is a flow chart of an example process 400 for associating an application with one or more contexts. In some implementations, a system (e.g., ad system 202 or the like) performs the process 400.

One or more application description pages for the application are identified (step 402). In some implementations, the name of the application or an application identifier is searched for at an application store where the application can be bought. In some implementations, the name of the application is submitted to a search system (e.g., search system 206 or the like) to identify application description pages.

Application description pages that are reviews of the application can be identified using various processes. For example, in some implementations, web pages of popular application review sites are crawled or searched. In some other implementations, a search engine is used to look for reviews of the application (e.g., by submitting the name of the application with the search term “review” to a web search engine). In some other implementations, web pages that include the name of the application (or another application identifier) are analyzed to determine whether those pages are reviews. For example, machine learning techniques can be applied (e.g., by training a classifier using review pages of other applications).

The application description pages are parsed for textual cues for associated contexts (step 404). A textual cue comprises text from a page indicating a topic. For example, a textual cue can be a keyword, a phrase, a writing style, a quotation, a hyperlink, meta information, or the like.

Contexts associated with the application description pages are added to a list of possible contexts to associate with the application (step 406). In some implementations, a relevance score is associated with each possible context. The relevance score can be based on, for example, how close a textual cue is located in an application description page to a mention of the application.

A linking page (a page linking to one or more of the application description pages) is identified (step 408). In some implementations, an index of pages (e.g., index 222 or the like) is searched (e.g., by search system 206 or the like) for linking pages.

It is determined whether any contexts have been previously associated with the linking page (step 410). For example, in some implementations, pages in an index of pages (e.g., index 222) are associated with contexts so that contextual ads can be placed on those pages. In those implementations, the contexts previously associated with the linking page can be added to the list of possible contexts (step 416). If no contexts have been previously associated with the linking page, steps 412-414 are performed to determine contexts associated with the linking page.

The linking page is parsed for textual cues for associated contexts (step 412). Other pages linking to the linking page are optionally checked to see if they have associated contexts (step 414). Any associated contexts found in steps 412-414 are added to the list of possible contexts to associate with the application (step 416). In some implementations, a relevance score is associated with each possible context. For example, higher relevance scores can be associated with possible contexts that are found on multiple linking pages.

It is determined whether there are any more linking pages (step 418). If so, steps 408-416 are repeated for additional linking pages. In some implementations, only a specified number of linking pages are used. For example, in some implementations, the linking pages are ranked according to quality scores and only a number (e.g., five or ten) of the top linking pages are used. Quality scores can be based on, for example, how often the linking pages are selected in response to a search for the name of the application.

The possible contexts are optionally ranked (step 420). For example, where each possible context is associated with a relevance score, the possible contexts can be ranked according to their scores.

One or more of the possible contexts are selected and associated with the application (step 422). In some implementations, all of the possible contexts are associated with the application. In some other implementations, only a specified number of the possible contexts are associated with the application. In various implementations, where the possible contexts have associated relevance scores, the relevance scores are retained with the associated contexts (e.g., for later use in selecting ads for the application).

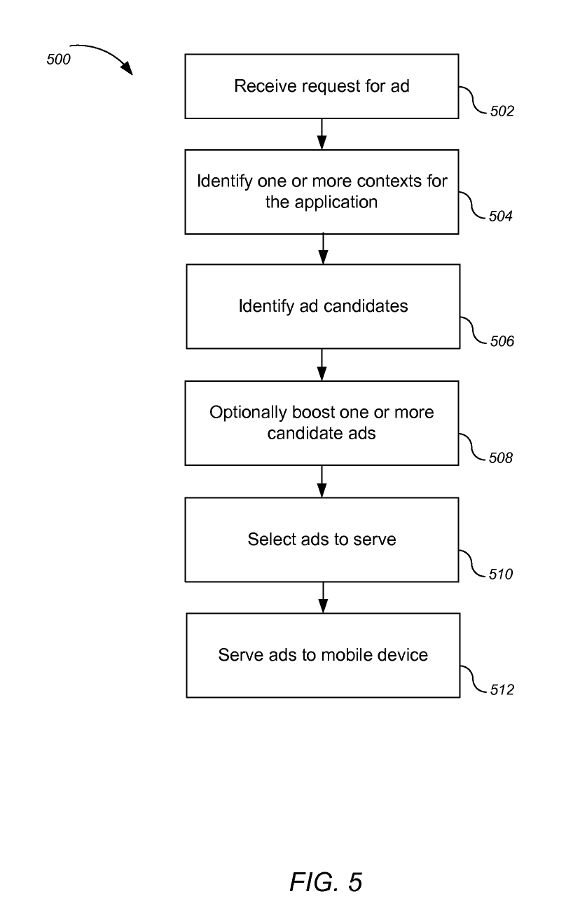

FIG. 5 is a flow diagram of a process 500 for serving one or more ads. In some implementations, the process 500 is performed by a system (e.g., ad system 202 or the like).

A request for one or more ads is received (step 502). The ads are to be served to an application on a mobile device. The request can be, for example, directly from the application on the mobile device, or from a publisher providing content to the application. In some implementations, the requests are executed by the mobile device, e.g., by the execution of particular code (e.g. javascript) when an application or application page is loading. In some implementations, the application on the mobile device provides identification (e.g., its name) with the request for ads.

One or more contexts associated with the application are identified (step 504). At least one of the contexts was determined based on an application description page for the application and one or more pages linking to the application description page. In some implementations, a context includes one or more keywords for topics of interest to users of the application. In some implementations, an application-context mapping (e.g., application-context mapping 214) is used to identify associated contexts.

Candidate ads are identified (step 506). Candidate ads can be identified using various information. For example, keywords, user information for the user of the mobile device (profile, demographics, location generally), and publisher's content can be used to identify candidate ads. For instance, ads can be associated with particular keywords that can be matched to other content (e.g., search query terms, web page text). Additionally, user information can identify likely interests of the user that can be matched to ad keywords.

In some implementations, candidate ads are scored based on various factors including the advertiser's financial agreements with the ad system (e.g., cost per impression), and the degree to which the ad matches the other content. Candidate ads can be ranked in order according to their score.

In some implementations, candidate ads are identified using the contexts associated with the application. For example, ads can be associated with contexts (e.g., using ad-context mapping 214), and ads associated with contexts that are also associated with the application can be identified as candidate ads.

In some other implementations, candidate ads that match the application (e.g., candidate ads associated with contexts that are also associated with the application) are boosted (step 508). In particular, in those implementations where candidate ads are scored and ranked, the score for candidate ads matching the application can be adjusted (e.g., by adding an additional weight to a scoring function or by adding a specified amount or percentage to the score). In some implementations, the amount of adjustment depends on a relevance score associated with the context that matches both the ad and the application (e.g., a relevance score as discussed with respect to FIG. 4). The adjusted score may or may not change the ranking of the ad depending on the score of the ads above the candidate ad in the ranking order. In some implementations, candidate ads that do not match the application are removed as candidate ads, or are demoted (e.g., by reducing their associated scores).

One or more ads are selected to serve to the application (step 510). In some implementation, the highest ranked candidate ad or ads are selected. The number of candidate ads selected for presentation to the user can depend on the number of ads requested (e.g., a page of an application can include one or more regions for receiving requested advertisements).

The selected one or more ads are served to the user (step 512). In some implementations, the selected ads are provided directly to the mobile device (e.g., where the application incorporates received ads into displayed application content). In some other implementations, the ads are sent to a publisher (e.g., publishers 106) for incorporation into content prior to sending the content to the mobile device. Various techniques for serving the selected ads to the user are possible.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. The computer storage medium can be, or be included in, a computer-readable storage device, a computer-readable storage substrate, a random or serial access memory array or device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a request to serve a content item to an application on a mobile device;
identifying a context associated with the application, the context being derived from an application description page for the application and one or more pages linking to the application description page, the context comprising one or more keywords associated with the application;
selecting a content item, from a collection of content items, using the context; and
serving the selected content item to the application on the mobile device.

2. The method of claim 1, where the content item is an advertisement.

3. The method of claim 1, where the context includes one or more of: news, sports, finance, music, television, travel, games, or food.

4. The method of claim 1, where the application description page comprises one of:
a page where the application can be purchased; or
a review of the application written by a user of the application.

5. The method of claim 1, where the context is based on:
a page context for each of the pages linking to the application description page.

6. The method of claim 1, where the application description page and the pages linking to the application description page are included in an index of pages.

7. The method of claim 1, where serving the selected content item includes:
determining one or more candidate content items;
determining whether the context for the application matches the one or more candidate content items;
modifying a score of each candidate content item determined to match the context for the application; and
selecting the selected content item from the one or more candidate content items using the scores for the candidate content items.

8. The method of claim 7, where each candidate content item is associated with one or more ad contexts, and where the ad contexts are identified using advertiser supplied keywords.

9. A method comprising:
identifying an application description page for an application for mobile devices;
identifying one or more pages linking to the application description page; and
determining a context for the application based on the application description page and the one or more pages linking to the application description page, the context comprising one or more keywords associated with the application.

10. The method of claim 9, where the application description page comprises one of:
a page where the application can be purchased; or
a review of the application written by a user of the application.

11. A system comprising:
one or more processors configured to interact with a computer storage medium in order to perform operations comprising:
receiving a request to serve a content item to an application on a mobile device;
identifying a context associated with the application, the context being derived from an application description page for the application and one or more pages linking to the application description page, the context comprising one or more keywords associated with the application;
selecting a content item, from a collection of content items, using the context; and
serving the selected content item to the application on the mobile device.

12. The system of claim 11, where the content item is an advertisement.

13. The system of claim 11, where the context includes one or more of: news, sports, finance, music, television, travel, games, or food.

14. The system of claim 11, where the application description page comprises one of:
a page where the application can be purchased; or
a review of the application written by a user of the application.

15. The system of claim 11, where the context is based on:
a page context for each of the pages linking to the application description page.

16. The system of claim 11, where the application description page and the pages linking to the application description page are included in an index of pages.

17. The system of claim 11, where serving the selected content item includes:
determining one or more candidate content items;
determining whether the context for the application matches the one or more candidate content items;
modifying a score of each candidate content item determined to match the context for the application; and
selecting the selected content item from the one or more candidate content items using the scores for the candidate content items.

18. The system of claim 17, where each candidate content item is associated with one or more ad contexts, and where the ad contexts are identified using advertiser supplied keywords.

19. A system comprising:
one or more processors configured to interact with a computer storage medium in order to perform operations comprising:
identifying an application description page for an application for mobile devices;
identifying one or more pages linking to the application description page; and
determining a context for the application based on the application description page and the one or more pages linking to the application description page, the context comprising one or more keywords associated with the application.

20. The system of claim 19, where the application description page comprises one of:
a page where the application can be purchased; or
a review of the application written by a user of the application.

21. A computer storage medium encoded with a computer program, the program comprising instructions that when executed by data processing apparatus cause the data processing apparatus to perform operations comprising:
receiving a request to serve a content item to an application on a mobile device;
identifying a context associated with the application, the context being derived from an application description page for the application and one or more pages linking to the application description page, the context comprising one or more keywords associated with the application;
selecting a content item, from a collection of content items, using the context; and
serving the selected content item to the application on the mobile device.

22. The computer storage medium of claim 21, where the content item is an advertisement.

23. The computer storage medium of claim 21, where the context includes one or more of: news, sports, finance, music, television, travel, games, or food.

24. The computer storage medium of claim 21, where the application description page comprises one of:
a page where the application can be purchased; or
a review of the application written by a user of the application.

25. The computer storage medium of claim 21, where the context is based on:
a page context for each of the pages linking to the application description page.

26. The computer storage medium of claim 21, where the application description page and the pages linking to the application description page are included in an index of pages.

27. The computer storage medium of claim 21, where serving the selected content item includes:
determining one or more candidate content items;
determining whether the context for the application matches the one or more candidate content items;
modifying a score of each candidate content item determined to match the context for the application; and
selecting the selected content item from the one or more candidate content items using the scores for the candidate content items.

28. The computer storage medium of claim 27, where each candidate content item is associated with one or more ad contexts, and where the ad contexts are identified using advertiser supplied keywords.

29. A computer storage medium encoded with a computer program, the program comprising instructions that when executed by data processing apparatus cause the data processing apparatus to perform operations comprising:
identifying an application description page for an application for mobile devices;
identifying one or more pages linking to the application description page; and
determining a context for the application based on the application description page and the one or more pages linking to the application description page, the context comprising one or more keywords associated with the application.

30. The computer storage medium of claim 29, where the application description page comprises one of:
a page where the application can be purchased; or
a review of the application written by a user of the application.
